(19) United States
(12) Patent Application Publication
(10) Pub. No.: US 2022/0371750 A1
(43) Pub. Date: Nov. 24, 2022

(54) Smart Umbilical For Satellite Systems

(71) Applicant: Busek Co. Inc., Natick, MA (US)

(72) Inventors: Darren D. Garber, Rancho Palos Verdes, CA (US); Vlad Hruby, Newton, MA (US); Andrew DeNucci, South Boston, MA (US); Matthew Averill, Charlestown, MA (US); Anthony Naccarato, Southborough, MA (US)

(73) Assignee: Busek Co. Inc., Natick, MA (US)

(21) Appl. No.: 17/748,147

(22) Filed: May 19, 2022

Related U.S. Application Data
(60) Provisional application No. 63/190,455, filed on May 19, 2021.

(51) Int. Cl. B64G 1/22; B64G 1/64

(52) U.S. Cl. CPC B64G 1/222; B64G 1/646

(57) ABSTRACT

An apparatus includes a primary device, a secondary device, and an umbilical system. The umbilical system comprises an umbilical linking the primary device and the secondary device, and a control system configured alter a directionality of the umbilical during deployment of the secondary device away from the primary device by at least controlling a configuration of a shape memory material comprising the umbilical.

### RELATED APPLICATIONS

This application hereby claims the benefit of and priority to U.S. Provisional Patent Application 63/190,455, titled “SMART UMBILICAL FOR SATELLITE SYSTEMS,” filed May 19, 2021, which is hereby incorporated by reference in its entirety.

### GOVERNMENT RIGHTS STATEMENT

This invention was made with U.S. Government support under Contract No. FA8814-20-C-0001 awarded by the U.S. Air Force Space & Missile Center. The Government may have certain rights in the subject invention.

### BACKGROUND

Spacecraft, such as orbital satellites, can employ umbilical links between a host spacecraft or mothership and child spacecraft or subordinate vehicle to exchange communications, provide propellant and electrical power while deployed via umbilical, away from the other vehicle. Fully flexible umbilicals allow for three degrees of freedom in movement among the endpoints of the umbilical, but being fully flexible these pose a risk of entanglement and are difficult to automate in low gravity environments. Rigid umbilicals, such as truss structures, do not provide for movement among the endpoints and thus do not require propulsive systems to maintain positioning. However, rigid umbilicals do not lend well to changes in relative positioning among the vehicles, limiting usefulness. Remote manipulator arms or 3D printers can be employed which provide for rigid linking with commanded geometry, typically for positioning of a subordinate vehicle with relation to a supervising vehicle. However, remote manipulator arms are costly in terms of weight and cost, and require complex control systems to ensure proper positioning.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example umbilical system in an implementation.

FIG. 2 illustrates example umbilical deployments in an implementation.

FIG. 3 illustrates example umbilical internals in an implementation.

FIG. 4 illustrates example umbilical internals in an implementation.

FIG. 5 illustrates an example umbilical control system in an implementation.

### DETAILED DESCRIPTION

Orbital satellites and other spacecraft, as well as airborne, aquatic, or terrestrial vehicles, can employ umbilical links between two or more vehicles or vehicle portions to exchange communications or to provide propellant or electrical power to one of the vehicles while deployed away from the other vehicle. Discussed herein are various examples of a smart umbilical, with the ability to be commanded to exhibit both flexible and rigid behaviors, and when possible, allowing for directionality in deployment of a secondary vehicle from a primary vehicle. This on-demand rigidity and directionality provides for controlled positioning of the secondary vehicle with respect to various factors, such as positioning relative to the primary vehicle, to position sensors to better sense particular properties or objects, or to allow for orientation of the secondary vehicle according to the desired task. This positioning or orientation of the secondary vehicle can be over more than one directional axis, such as in two or three axes, providing for versatile positioning and orientation of the secondary vehicle. Moreover, the reaction mass of the umbilical itself is reduced with respect to rigid umbilicals or remote manipulator arms, and other propellant or reaction control systems are not needed for the secondary vehicle to establish this positioning and orientation.

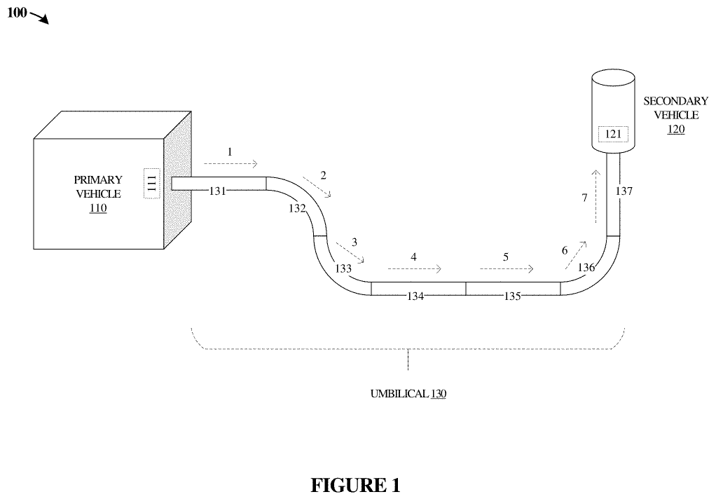

As first example, FIG. 1 is presented. FIG. 1 includes system 100 including primary vehicle 100, secondary vehicle 120, and umbilical 130. Primary vehicle 110 might house secondary vehicle 120 internally or externally, such as in a bay or docking port, side port, external coupling, secondary payload deployer, or other various structures and arrangements. When a deployment of secondary vehicle 120 away from primary vehicle 110 is desired, umbilical 130 is employed to couple the two vehicles. Umbilical 130 can be housed in either primary vehicle 110 or secondary vehicle 120, but for the examples herein, umbilical 130 is housed in secondary vehicle 120. This housing can be a reel, spool, or compartment which keeps umbilical 130 in a stored or stowed configuration which is typically more compact than when extended/deployed. Although a relative ‘thick’ umbilical 130 is shown, the scale is merely representative, and umbilical 130 is fit within a structure associated with secondary vehicle 120 when undeployed.

A controlled deployment occurs which extends umbilical 130 outward from the source vehicle, namely outward from secondary vehicle 120. This controlled deployment might be initiated by a control system of primary vehicle 110 or secondary vehicle 120. In one example, umbilical 130 is spooled up on a motorized drum which can be commanded to unwind umbilical 130. During the outward deployment of umbilical 130 from secondary vehicle 120, a series of directional changes are made by umbilical 130 which impact the positioning and orientation of secondary vehicle 120 with respect to primary vehicle 110. In FIG. 1, these series of directional changes are indicated by steps 1-7, with step 1 indicating the first phase of unwinding of umbilical 130 and initial separation phase between primary vehicle 110 and secondary vehicle 120. Step 2 indicates a first direction change, step 3 a second direction change, and steps 4-5 straight or non-changing directions, followed by step 6 having a direction change and step 7 having no direction change to reach a final position of secondary vehicle 120. In this manner, a controlled extension of umbilical 130 is effected in a series of steps, each having an associated directionality.

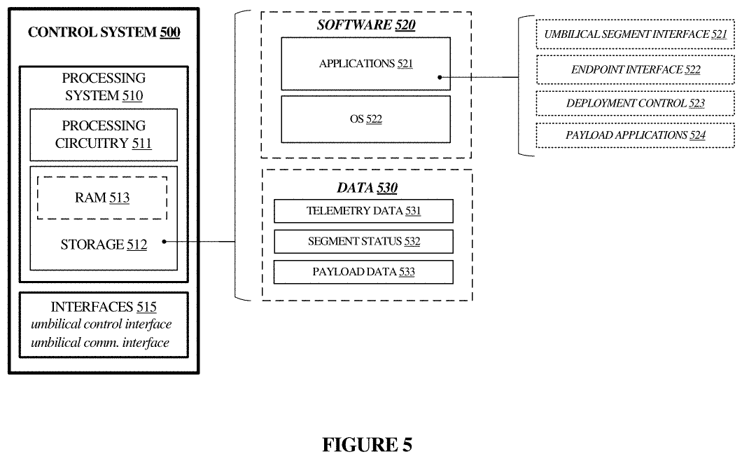

To control this directionality, umbilical 130 comprises a series of segments 131-137 which are formed from specialized controllable materials. These materials are included in a class of materials referred to as shape memory materials or shape memory alloys (SMA), which change a shape in response to a change in temperature or an electrical current (which stimulates a temperature change in the material). Many shape memory materials are resettable, and can be employed repeatedly to change shape after a reset process using applied heat. Ferromagnetic fluids contained in capillary lines may also be used in place of shape memory alloys. In this example, each segment 131-137 of umbilical 130 includes one or more portions of shape memory material configured to produce a directional/orientation change in the deployment of umbilical 130 for that particular section. Controllable SMA strands within umbilical 130 act as actuators for each particular segment of umbilical 130, which may produce a curve in umbilical 130 or produce a torque on umbilical 130. A control system included in either primary vehicle 110 or secondary vehicle 120 can determine which segment is presently extending beyond secondary vehicle 120 and can responsively command umbilical 130 to change direction for that present segment. Example control systems 111 and 121 are shown in FIG. 1, and further exemplified in FIG. 5. As each segment is sequentially deployed, an incremental change in position and orientation of secondary vehicle 120 is made, ultimately leading to a target final position/orientation.

Shape memory materials comprise materials and alloys can be deformed when below a first threshold temperature, but return or reset to a pre-deformed or memory shape when heated above a second threshold temperature. The first and second threshold temperatures for deformation and return to the memory shape can be similar or different temperatures, which may have a hysteresis effect when two different temperatures are involved. Some shape memory materials can have a one-way shape memory, while other have a two-way shape memory. Example shape memory materials or shape memory alloys include any material that exhibits the shape memory effect, such as nitinol (a metal alloy comprising nickel and titanium), certain metal alloys, and certain types of polymers (e.g. polylactic acid). In addition to resettable materials that exhibit the shape memory effect, one-time use materials might be employed in umbilical 130, such as polymers (e.g. polystyrene or polyester) that shrink in size when heated by an embedded wire or external application of heat.

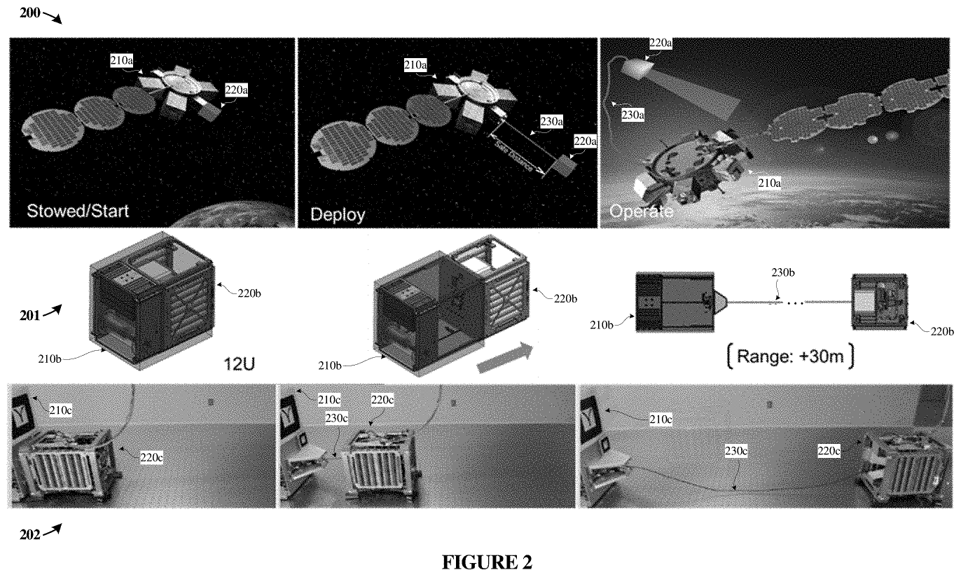

FIG. 2 includes several operational examples 200-202 showing deployment of a second satellite device 220 from a first satellite device 210, while connected by umbilical 230. In FIG. 2, the secondary vehicle discussed in FIG. 1 comprises a satellite device or spacecraft, referred to as a spacecraft on umbilical line (SOUL). Example 200 shows an example orbital or space-based deployment of primary satellite 210a having one or more externally-mounted secondary spacecraft 220a which are deployed using controllable umbilical 230a. Example 201 shows an example nested CubeSat arrangement for orbital or space-based deployment of 12U CubeSat primary satellite 210b having a nested secondary spacecraft 220b which is deployed using controllable umbilical 230b. Example 202 shows a table-top testing example of primary satellite 210c having one or more externally-mounted secondary spacecraft 220c which are deployed using controllable umbilical 230c.

Umbilical 230(a-c) utilizes embedded segments of shape memory materials to provide control and stability to the umbilical in micro-gravity environments. Example lengths of umbilical 230 include 30-50 meters, although this can vary based on the application or mission. One or more segments can be employed, although seven segments are shown in FIG. 1, a different quantity can instead be used. The volume and mass of the umbilical will vary based on the thickness, length, and materials, but may fit into a 1U or 2U CubeSat form factor on a spool or reel. The spool may reside in either endpoint vehicle, but control for the deployment and directionality might be in the deployed vehicle. Some implementations employ a buffer length or safe distance buffer between the primary spacecraft and the secondary spacecraft before directionality is controlled to prevent unwanted collisions or mechanical interferences and ensure that initial separation of the secondary spacecraft away from the primary spacecraft has occurred.

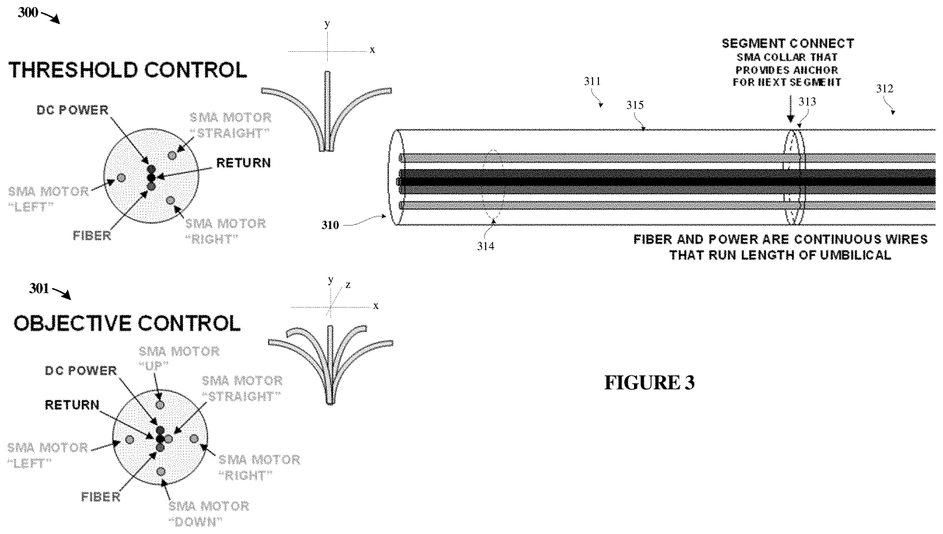

FIG. 3 illustrates two example internal configurations 300-301 of any of the umbilicals discussed herein. FIG. 3 shows umbilical 310 which comprises several segments (311, 312), segment connection 313, and segment internals 314 comprising shape memory alloy (SMA) strands or portions as well as several control and communication links. Umbilical 310 also includes sheathing 315 comprising a flexible cover or other suitable enclosure for umbilical 310 in the deployment environment.

Configuration 300 shows a threshold control arrangement for umbilical 310. This threshold control provides for flexing of umbilical 310 in two dimensions (x, y) using three SMA portions (straight, left, right). By controlling activation of each of these three SMA portions, for each segment individually, a directionality in x-y planes for umbilical 310 can be controlled. Configuration 301 shows an objective control arrangement for umbilical 310. This objective control provides for flexing of umbilical 310 in three dimensions (x, y, z) using five SMA portions (straight, left, right, curve up, curve down). By controlling activation of each of these five SMA portions, for each segment individually, a directionality in x-y-z planes for umbilical 310 can be controlled. Orientation can be similarly controlled using combinations of the aforementioned SMA portions.

To activate a particular SMA portion, an electrical current can be passed through the section which increases a temperature of the section and leads to a deformation of the shape memory material of the particular section. By selective placement and positioning of the SMA portions relative to each other within umbilical 310, directionality in a bending of the corresponding segment of umbilical 310 can be achieved. Each segment of umbilical 310 is controlled independently, thus a series of commands are issued during deployment to affect each segment as that segment is ejected from the spool or vehicle. A series of couplings (313) couple each segment together, and make any associated electrical, optical, communication, power, or mechanical connections. Some of the links may be made unbroken and run the length of umbilical 310, while others may only extend within each segment and couple to the next segment, and so on, until an endpoint of umbilical 310.

In some examples, a segment-addressable control scheme is employed, where each segment has an associated identifier or address and each SMA portion within the segment has a sub-identifier or sub-address. A controller in an endpoint device or vehicle can selectively activate any SMA portion using the segment address and sub-address to select a particular SMA portion and affect the directionality of that SMA portion. Circuitry may be included in each segment to ignore commands not intended for the particular segment or to respond to commands for only that segment. Power switching or control circuitry can be included within each segment to selectively apply a current to a particular SMA portion in accordance with the addressable control scheme noted above. In other examples, the endpoint includes such circuitry and addressable elements, such that an SMA portion only extends a memory material for the particular segment, and a non-memory material conductor (e.g. wire) extends the remaining length of umbilical 310 to reach the controlling endpoint. Other control schemes and arrangements are possible to achieve individual control over each SMA portion within each segment.

Also, umbilical 310 includes DC power links, one or more communication links, and ground/return links. The communication links can comprise high bandwidth conductive or optical links (such as fiber optic). DC power (plus ground/return) can be employed to power the secondary vehicle from the primary vehicle to perform various tasks or missions by the secondary vehicle without having to carry internal power generation elements. Advantageously, the secondary vehicle can be made lightweight in comparison to the primary vehicle. Also, deployment and retraction control of umbilical 310 can be provided by control elements within the secondary vehicle, lending to a tighter control loop with less error as the secondary vehicle typically will contain acceleration/movement sensors which can provide sensing of position and orientation during deployment.

The physical configuration of strands within umbilical 310 can vary based on application, but include straight segments, coiled segments, helical segments, or other shapes which can be commanded to straighten to alter the directionality of the particular segment. Directionality can thus be controlled for the particular segment to turn in a selected quantity of degrees of rotation or deform in (+/−) x, y, or z directions. Ferromagnetic fluids contained in capillary lines may also be used in place of shape memory alloys and controlled using applied magnetic/electric fields.

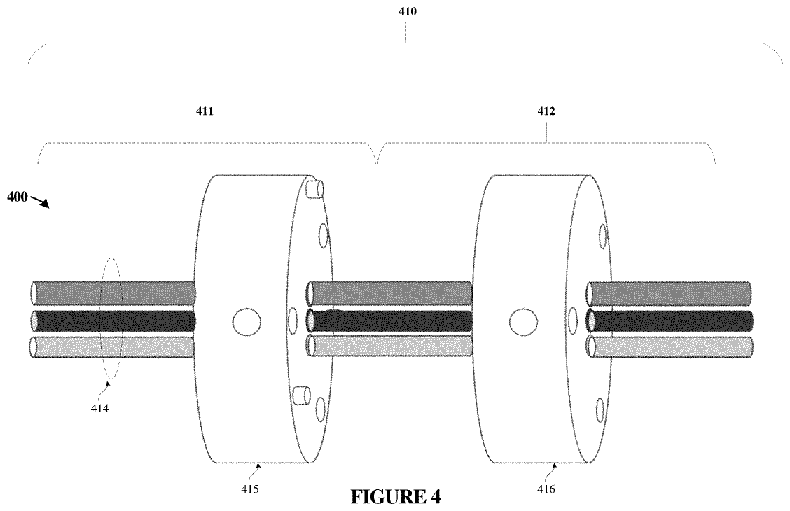

FIG. 4 illustrates configuration 400 showing one example implementation of internal components within umbilical 410. Configuration 400 illustrates electromechanical connection of individual umbilical segments 411 and 412, with data and power pass-throughs during manufacture of umbilical 410. Segment connections 415-416 comprising collar elements are employed on the ends of adjacent segments of umbilical 410 to couple the segments together mechanically and for coupling of various control or command connections when employed. Indexing or pins can be employed to ensure desired alignment among segment connections 415-416 during manufacture. SMA connections can be made within segment connections 415-416, or may be made as otherwise discussed herein. In one example arrangement, a first portion of the internal links extend the full length of umbilical 410 (DC power, return, and communications), while another portion of the internal links (SMA strands) only extend within the particular segment. In other examples, segment connections 415-416 can be used to modularize umbilical 410 and provide for segment connections among all internal links (DC power, return, and communications, SMA strands).

FIG. 5 is a block diagram illustrating an implementation of control system 500. Control system 500 illustrates an example of any of the umbilical control systems or umbilical controllers discussed herein, such as control systems 111 and 121 of FIG. 1. Control system 500 includes processing system 510 and interface(s). Processing system 510 includes processing circuitry 511 and data storage system 512 which can include random access memory (RAM) 513, although additional or different configurations of elements can be included.

Processing circuitry 511 can be implemented within a single processing device but can also be distributed across multiple processing devices or sub-systems that cooperate in executing program instructions. Examples of processing circuitry 511 include general purpose central processing units, microprocessors, application specific processors, and logic devices, as well as any other type of processing device. In some examples, processing circuitry 511 includes physically distributed processing devices.

Interface 515 includes umbilical control interfaces and communication interfaces, which may include communication links or communication networks. The communication interfaces can include Ethernet interfaces, serial interfaces, serial peripheral interface (SPI) links, I2C interfaces, universal serial bus (USB) interfaces, SMBus interfaces, PMBus interfaces, UART interfaces, wireless interfaces, or one or more local or wide area network communication interfaces which can communicate over Ethernet, Ethernet-style, or Internet protocol (IP) links. Interface 515 can include network interfaces configured to communicate using one or more network addresses, which can be associated with different umbilical segments as well as vehicles/endpoints. Examples of interface 515 include network interface card equipment, transceivers, modems, and other communication circuitry. Interface 515 can communicate with elements of an umbilical and associated deployment system to control deployment, directionality, orientation, and retraction of segments of the umbilical and the umbilical as a whole.

Storage system 512 and RAM 513 together can comprise a non-transitory data storage system, although variations are possible. Storage system 512 and RAM 513 can each comprise any storage media readable by processing circuitry 511 and capable of storing software and OS images. RAM 513 can include volatile and nonvolatile, removable and non-removable media implemented in any method or technology for storage of information, such as computer readable instructions, data structures, program modules, or other data. Storage system 512 can include non-volatile storage media, such as solid-state storage media, flash memory, phase change memory, or magnetic memory, including combinations thereof. Storage system 512 and RAM 513 can each be implemented as a single storage device but can also be implemented across multiple storage devices or sub-systems. Storage system 512 and RAM 513 can each comprise additional elements, such as controllers, capable of communicating with processing circuitry 511.

Software or data stored on or in storage system 512 or RAM 513 can comprise computer program instructions, firmware, or some other form of machine-readable processing instructions having processes that when executed a processing system direct control system 500 to operate as described herein. Software 520 illustrates a detailed view of an example configuration of storage 512 or RAM 513. It should be understood that different configurations are possible. Software 520 includes applications 521 and operating system (OS) 522. Software applications each comprise executable instructions which can be executed by control system 500 for operating a computing system or cluster controller or operating other circuitry according to the operations discussed herein.

Software 520 can reside in RAM 513 during execution and operation of control system 500, and can reside in non-volatile portions of storage system 512 during a powered-off state, among other locations and states. Software 520 can be loaded into RAM 513 during a startup or boot procedure as described for computer operating systems and applications. Software 520 can receive operator input through operator control interfaces. This operator input can include user commands, as well as other input, including combinations thereof.

Storage system 512 can comprise flash memory such as NAND flash or NOR flash memory, phase change memory, magnetic memory, among other solid-state storage technologies. As shown in FIG. 5, storage system 512 includes software 520. As described above, software 520 can be in a non-volatile storage space for applications and OS during a powered-down state of control system 500, among other operating software.

For example, software 520 can drive control system 500 to control/power deployment, directionality, orientation, and retraction of segments of an umbilical and for umbilical as a whole. Moreover, software 520 can facilitate communication between endpoints along an umbilical, such as between a primary and secondary vehicle. These communications can be related to the umbilical itself, or related to the operations of the endpoint vehicles, such as telemetry, sensing, mission operations, power control, power monitoring, and other various communications. When payloads are included on the secondary vehicle, such as sensors, communication systems, transceivers, experiments, instruments, and other elements, communications for the payloads can be transported over the umbilical and handled by interfaces 515 of control system 500.

In one example, software 520 includes umbilical segment interface 521 configured to communicate with each segment of an umbilical during deployment of the umbilical as well as during retraction and steady-state of the umbilical. Endpoint interface 522 establishes communications between endpoints on the umbilical, such as to exchange communications between a primary and secondary vehicle as well as to transport communications, telemetry, data, commands, or control for payloads housed in the secondary vehicle. Deployment control 523 can control power control electronics (not shown) used to alter a directionality of the umbilical segments, such as to selectively apply electrical current to particular segments of the umbilical to affect deployment directionality and orientation, or to reset the associated segments for retraction. Deployment control 523 can include knowledge of the state of the umbilical segments to determine control processes for each segment, which can take into account a current deployment state, current acceleration, position, or orientation of the secondary vehicle, inertial properties of the secondary vehicle, or other factors. This knowledge can be applied to one or more control algorithms or control loops to establish a desired deployment for the secondary vehicle. Deployment control 523 can operate in conjunction with umbilical segment interface 521 to communicate with individual segments, such as when an addressable scheme is employed for the segments. Payload applications 524 can include any software or applications used to interface, control, or otherwise affect payloads deployed to the vehicle to perform one or more tasks, missions, or operations using on-board systems of the vehicle. This can include tasks for various sensors, communication systems, transceivers, experiments, instruments, and other elements associated with a mission or scientific payload.

In addition to software 520, other data 530 can be stored by storage system 512 and RAM 513. Data 530 can comprise telemetry data 531, segment status 532, and payload data 533. Telemetry data 531 can include any data related to control of the umbilical and secondary vehicle with relation to the primary vehicle. Telemetry data 531 can include position data, acceleration data, inertial data, orientation data, on-board systems status and operational condition data, or other data related to operation of the umbilical and secondary vehicle. Segment status 532 includes information related to the umbilical deployment state, such as present deployed status or length, present orientations or directions of each segment, logs of number of uses of each SMA strand in each segment, failure indications of segments or SMA strands, electrical current limits for each SMA strand, current thresholds or temperature thresholds for each SMA strand, or other suitable data. Moreover, the umbilical can include one or more sensors, such as temperature sensors or current sensors which can provide data to aid in control and function of the umbilical. This associated data can be stored in segment status 532. Segment status 532 can be provided over one or more communication links to the primary vehicle and to other external entities. Payload data 533 includes data related to the operation or control of any of the payloads mentioned above, noted for payload applications 524.

Control system 500 is generally intended to represent a computing system with which at least software 520 is deployed and executed in order to render or otherwise implement the operations described herein. However, control system 500 can also represent any computing system on which at least software 520 can be staged and from where software 520 can be distributed, transported, downloaded, or otherwise provided to yet another computing system for deployment and execution, or yet additional distribution.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various materials and manufacturing processes discussed herein are employed according to the descriptions above. However, it should be understood that the disclosures and enhancements herein are not limited to these materials and manufacturing processes and can be applicable across a range of suitable materials and manufacturing processes. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

What is claimed is:

1. An apparatus, comprising:
a primary device;
a secondary device; and
an umbilical system comprising:
an umbilical linking the primary device and the secondary device;
a control system configured alter a directionality of the umbilical during deployment of the secondary device away from the primary device by at least controlling a configuration of a shape memory material comprising the umbilical.

2. The apparatus of claim 1, wherein the umbilical comprises:
a plurality of segments each housing one or more shape memory material portions, a power link, and a control link for the one or more shape memory material portions; and
segment connection elements on ends of each segment to mate the power link and control link to adjacent segments.

3. The apparatus of claim 2, wherein the control link of each segment is coupled to the control system and, responsive to control signals dispatched from the control system, employ electrical current to modify a state of the one or more shape memory material portions and alter the directionality of the umbilical.
